(19) United States
(12) Patent Application Publication
(10) Pub. No.: US 2025/0110311 A1
(43) Pub. Date: Apr. 3, 2025

(54) VIBRATING ACTUATOR, OPTICAL DEVICE, AND ELECTRONIC DEVICE

(71) Applicant: CANON KABUSHIKI KAISHA, Tokyo (JP)

(72) Inventors: MEI INOUE, Kanagawa (JP); KEI SUEFUJI, Tokyo (JP)

(21) Appl. No.: 18/896,634

(22) Filed: Sep. 25, 2024

(30) Foreign Application Priority Data
Sep. 29, 2023 (JP) 2023-169956

(51) Int. Cl. G02B 7/08

(52) U.S. Cl. CPC G02B 7/08

(57) ABSTRACT

A vibrating actuator includes a vibrator including an electromechanical energy conversion element and an elastic body, and a contact body in contact with the vibrator, the vibrator and the contact body moving relatively in a first direction. The vibrating actuator includes a pedestal, a holding member configured to hold the vibrator, held on the pedestal, having a slope intersecting with the first direction, and moving in the first direction along with relative movement of the vibrator, and an output unit held on the pedestal so as to be movable in a second direction intersecting with the first direction, being in contact with the slope, and moving along with the movement of the holding member.

### BACKGROUND

### Field

The present disclosure relates to a vibrating actuator, an optical device, and an electronic device.

### Description of the Related Art

There are known various configurations of vibrating actuators that use electromechanical energy conversion elements, such as piezoelectric elements, converting electrical energy into mechanical energy. For example, there is known a vibrating actuator that includes a contact body, a vibrator in which two protrusions are provided on the front side of a flat elastic body and a piezoelectric element is bonded to the back side of the elastic body, and a pressure member for bringing the two protrusions and the contact body into pressure contact. The back side of the elastic body herein refers to the side on which the protrusions, to be described below, are not formed.

In the vibrating actuator, a predetermined alternating-current voltage (hereinafter, also called a driving voltage) is applied to the electromechanical energy conversion element to generate an elliptic motion or a circular motion at a tip of each of the two protrusions in a plane that includes a direction connecting the two protrusions and a protruding direction of the protrusions. Accordingly, the contact body receives a friction driving force from the two protrusions (vibrator), and the vibrator and the contact body can be moved relatively (hereinafter, also referred to as being subjected to a “relative movement”) in the direction connecting the two protrusions.

The vibrating actuator obtains power to drive a body to be driven from such a relative movement. For example, in the vibrating actuator discussed in Japanese Patent Application Laid-Open No. 2023-19753, a tension spring is arranged with a shaft, which is provided on a holding member holding the vibrator, as a fulcrum, a projecting portion as a point of load, and a spring placement part, which is formed on a pressure member engaging with the shaft, as a point of effort. The vibrator is biased by the tension spring on the principle of leverage and is brought into pressure contact with the contact body. An output unit formed on the holding member engages with the body to be driven, thereby transmitting the driving force of the vibrating actuator to the body to be driven.

However, in the vibrating actuator discussed in Japanese Patent Application Laid-Open No. 2023-19753, since the vibrator has two protrusions and a rectangular shape that is long in one direction, a direction of output motion (output direction) is limited to a long-side direction of the vibrator. In addition, since the relative movement between the vibrator and the contact body is used as the output, the amount of output movement is limited to the amount of relative movement.

### SUMMARY

The present disclosure advantageously provides a vibrating actuator with an improved design flexibility. The present disclosure also advantageously provides an optical device and an electronic device that include a vibrating actuator with an improved design flexibility.

According to some embodiments, a vibrating actuator including a vibrator including an electromechanical energy conversion element and an elastic body, and a contact body in contact with the vibrator, the vibrator and the contact body moving relatively in a first direction, includes a pedestal, a holding member configured to hold the vibrator, held on the pedestal, having a slope intersecting with the first direction, and moving in the first direction along with relative movement of the vibrator, and an output unit held on the pedestal so as to be movable in a second direction intersecting with the first direction, being in contact with the slope, and moving along with the movement of the holding member.

Further features of the present disclosure will become apparent from the following description of exemplary embodiments with reference to the attached drawings.

### BRIEF DESCRIPTION OF THE DRAWINGS

FIG. 1 is an exploded perspective view of a vibrating actuator according to a first exemplary embodiment of the present disclosure.

FIG. 2A is an isometric projection view of the vibrating actuator according to the first exemplary embodiment, FIG. 2B is a front view thereof, FIG. 2C is an A-A cross-sectional view thereof, and FIG. 2D is a B-B cross-sectional view thereof.

FIGS. 3A and 3B are diagrams illustrating vibration modes according to the first exemplary embodiment.

FIG. 4A is a bottom view of the vibrating actuator that produces output in the Y direction according to the first exemplary embodiment, and FIG. 4B is an enlarged bottom view thereof.

FIG. 5A is a bottom view of the vibrating actuator that is driven to the left side of the drawing surface, and FIG. 5B is a bottom view of the vibrating actuator that is driven to the right side of the drawing surface, illustrating generation of force by the vibrating actuator that is configured to produce output in the Y direction according to the first exemplary embodiment.

FIG. 6A is an isometric projection view of the vibrating actuator that is configured to produce output in the Z direction according to the first exemplary embodiment, FIG. 6B is an enlarged front view thereof, and FIG. 6C is a front view of the vibrating actuator that is driven to the right side of the drawing surface, illustrating the generation of force by the vibrating actuator.

FIG. 7A is a bottom view of a vibrating actuator according to a second exemplary embodiment of the present disclosure, FIG. 7B is an enlarged bottom view thereof, and FIG. 7C is a bottom view of the vibrating actuator that is driven to the left side of the drawing surface, illustrating the generation of force by the vibrating actuator.

FIG. 8A is a bottom view of a vibrating actuator according to a third exemplary embodiment of the present disclosure, FIG. 8B is an enlarged bottom view thereof, and FIG. 8C is a bottom view of the vibrating actuator that is driven to the left side of the drawing surface, illustrating the generation of force by the vibrating actuator.

FIG. 9A is a top view schematically illustrating a configuration of an imaging apparatus that uses a vibrating actuator according to a fourth exemplary embodiment of the present disclosure, and FIG. 9B is a block diagram thereof.

### DESCRIPTION OF THE EMBODIMENTS

The present disclosure will be described in further detail below with reference to various exemplary embodiments, features, and aspects and the drawings.

In a vibrating actuator of translational movement type, a vibrator has two protrusions and a rectangular shape that is long in one direction, so that the direction of output motion (output direction) is limited to a longitudinal direction of the vibrator. In addition, since the relative movement between the vibrator and the contact body is used as the output, the amount of output movement is limited to the amount of relative movement. Therefore, the inventors have considered a way to improve a design flexibility of the vibrating actuator. As a result, they have found that by providing a cam member having a slope and an output unit in contact with the slope to a holding member that holds the vibrator, it is possible to obtain an output in a second direction that intersects with a first direction that is the direction of the relative movement of the vibrator.

In other words, in the configurations of the present disclosure, a driving direction and the output direction can be converted by a mechanism as described below. First, the vibrator moves in the first direction, and the holding member that holds the vibrator moves along with the movement of the vibrator. The output unit in contact with the slope of the holding member is held on a pedestal so as to be movable in the second direction that intersects with the first direction. Thus, the output unit moves in the second direction along with the movement of the holding member. This makes it possible to obtain an output in a direction different from the driving direction, thereby providing a vibrating actuator with an improved design flexibility.

Furthermore, it has conventionally been preferable to set the size of the vibrating actuator in the driving direction to be larger than the driving amount of the vibrator. Converting the output direction reduces the size of the vibrating actuator in the output direction even in a configuration for driving a very small amount.

Hereinafter, examples of configurations of the present disclosure will be described in detail as exemplary embodiments.

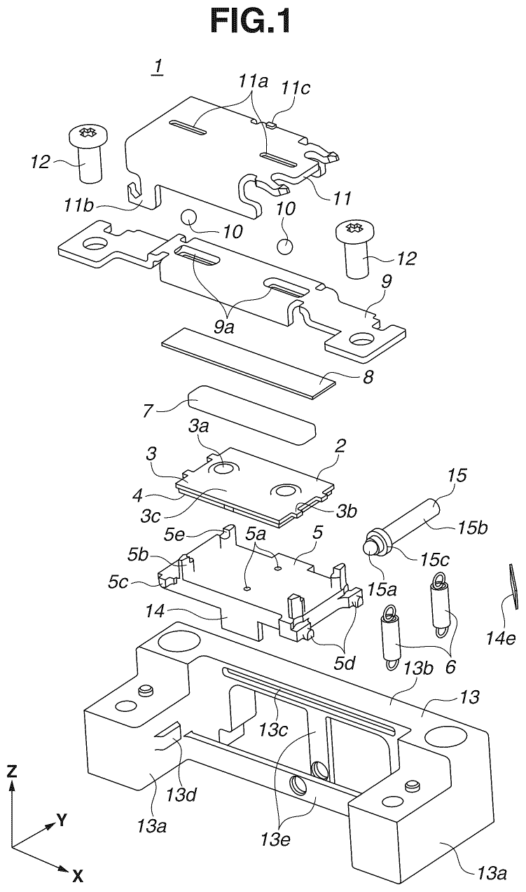

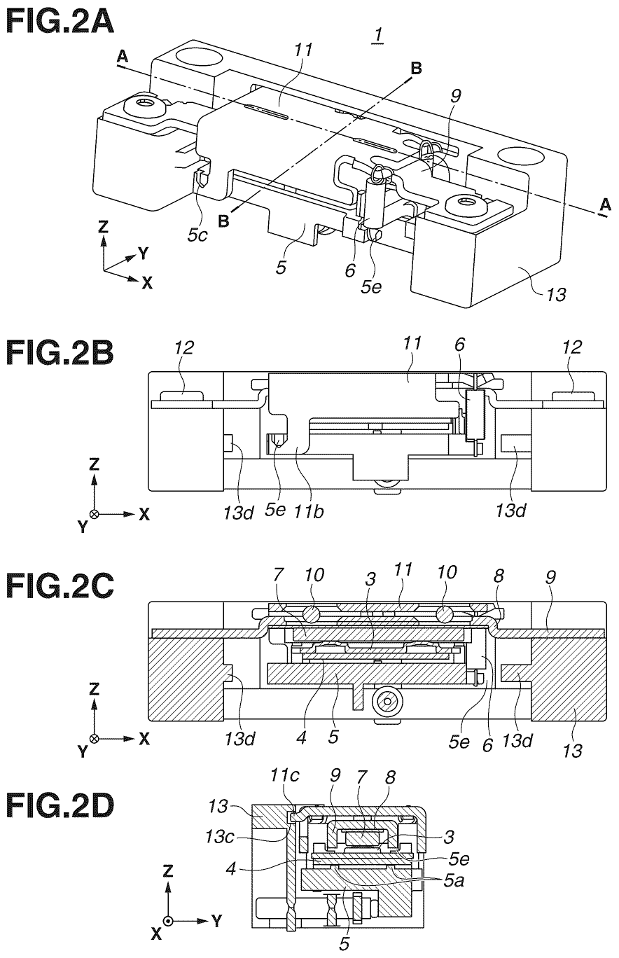

A first exemplary embodiment is an example in which the present disclosure is applied to a reciprocating vibrating actuator, and details thereof will be described with reference to FIGS. 1 and 2A to 2D. FIG. 1 is an exploded perspective view of a vibrating actuator 1 according to the first exemplary embodiment of the present disclosure, and FIG. 2A is an isometric projection view of the vibrating actuator 1 according to the first exemplary embodiment. A relative movement direction of a vibrator 2 will be defined as an X direction, a pressure direction will be defined as a Z direction, and a direction perpendicular to the X direction and the Z direction will be defined as a Y direction.

An elastic body 3 includes a rectangular main body 3c and a plurality of (herein, two pieces×two positions=four) extension parts 3b that extends from a plurality of positions (herein, two positions) in the X direction of the main body 3c. The plurality of (herein, four) extension parts 3b are different in the positions in the X direction of the main body 3c and in positions in the direction perpendicular to the X direction and the Z direction. It can also be said that the extension parts 3b protrude from a plurality of positions (here, four position) in the main body 3c.

A piezoelectric element 4, which is an electromechanical energy conversion element, is fixed to the elastic body 3 with an adhesive or the like. A flexible printed board (not illustrated) is fixed to the piezoelectric element 4 on the side opposite to the elastic body 3. These components form the vibrator 2. The piezoelectric element 4 and the flexible printed board are fixed with an anisotropic conductive paste or anisotropic conductive film that allows current to flow only in the Z direction.

The material of the elastic body 3 is preferably a material with low vibration damping, such as metal or ceramics. In the manufacture of the elastic body 3, protrusions 3a may be integrally provided by press molding or cutting, or the protrusions 3a may be produced separately and then fixed thereto afterward by welding, adhesion, or the like. A plurality of protrusions 3a may be provided as in the present exemplary embodiment, or only one protrusion 3a may be provided.

The piezoelectric element 4 is made of lead zirconate titanate. Alternatively, the piezoelectric element 4 may be made mainly of a lead-free piezoelectric material, such as barium titanate or bismuth sodium titanate. Electrode patterns are formed on both sides of the piezoelectric element 4, and power is supplied from the flexible printed board. The vibrator 2 is composed of the elastic body 3, the piezoelectric element 4, and the flexible printed board.

The vibrator 2 is pressed into contact with a contact body 7 by a pressure mechanism described below, and the vibrator 2, a holding member 5, pressure springs 6, and a second guide member 11 can move integrally in the X direction by the elliptic motion of the vibrator 2 described below. The flexible printed board is fixed to the holding member 5 with double-sided adhesive tape or the like.

The contact body 7 is fixed to a first guide member 9 by an adsorption force of rubber 8. The rubber 8 also plays a role in vibration damping, making it difficult for vibration from the vibrator 2 to be transmitted to the first guide member 9. The contact body 7, the first guide member 9, and the rubber 8 may be fixed by adhesion or screwing. The contact body 7 is made of a highly wear-resistant metal, ceramic, resin, or a composite material thereof. In particular, a material obtained by nitriding stainless steel, such as SUS420J2, is preferable from the viewpoints of wear resistance and mass productiveness. The first guide member 9 is also fixed with screws 12 to a pedestal 13 that is a fixed member.

Next, a linear guide mechanism of the present exemplary embodiment will be described. The first guide member 9 and the second guide member 11 are provided with two rolling grooves 9a and two rolling grooves 11a, respectively, to sandwich two balls 10. Accordingly, when the vibrating actuator 1 is driven, the balls 10 roll in the rolling grooves 9a and 11a, thereby the vibrator 2, the holding member 5, the pressure springs 6, and the second guide member 11 can move smoothly in the X direction. The material of the first guide member 9 and the second guide member 11 may preferably be hard in order to receive pressure by the two rolling grooves 9a and two rolling grooves 11a, respectively. In addition, from the viewpoint of workability, the material is preferably metal, in particular, stainless steel.

A groove 13c provided on the pedestal 13 and a tilt regulating part 11c provided on the second guide member 11 are fitted together with looseness, i.e., with a certain amount of play, thereby rotation around an X axis is regulated. The pedestal 13 is composed of two fixing parts 13a provided with screw holes and retaining portions for fixing the first guide member 9 and holes for fixing the pedestal 13 to an external component, and a coupling part 13b that couples the two fixing parts 13a. The groove 13c is formed in a portion of the coupling part 13b in the X direction. The pedestal 13 is made of resin from the viewpoints of workability and sliding property.

The flexible printed board is fixed to the coupling part 13b. The coupling part 13b also serves a function of storing a curved part of the flexible printed board that moves in a curved manner along with the movement of the vibrator 2 and the holding member 5.

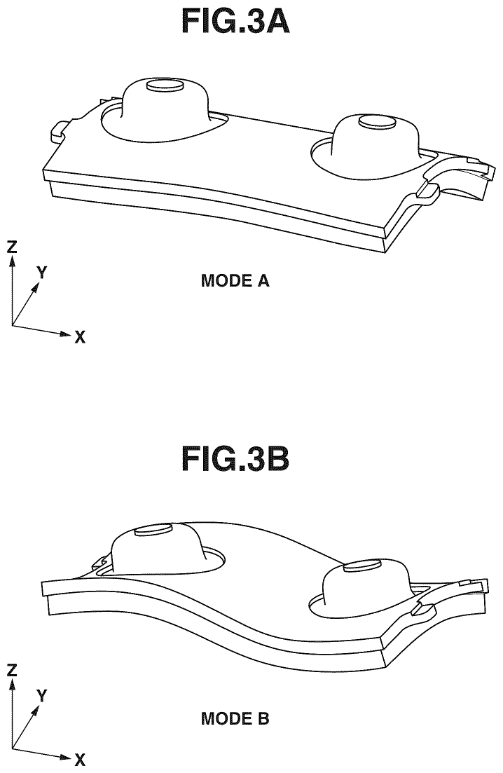

Next, the vibration modes excited in the vibrator 2 will be described with reference to FIGS. 3A and 3B. In the present exemplary embodiment, an alternating-current voltage is applied to the piezoelectric element 4 via the flexible printed board to excite standing waves (out-of-plane bending vibrations) having different phases in the vibrator 2, thereby a vibration that is a composite of these out-of-plane bending vibrations is generated.

A mode A, which is a first vibration mode, is a primary out-of-plane bending vibration mode in which two nodes appear parallel to the X direction that is a long-side direction of the vibrator 2. By vibrations in the mode A, the two protrusions 3a are displaced in the Z direction that is the pressure direction. A mode B, which is a second vibration mode, is a secondary out-of-plane bending vibration mode in which three nodes appear approximately parallel to the Y direction that is a short-side direction of the vibrator 2. By vibrations in the mode B, the two protrusions 3a are displaced in the X direction.

The vibrations in these modes A and B are combined to allow the two protrusions 3a to perform an elliptic or circular motion in the XZ plane. When the contact body 7 is brought into pressure contact with the protrusions 3a, a frictional force is generated in the X direction to generate a driving force (thrust force) that relatively moves the vibrator 2 and the contact body 7. In the present exemplary embodiment, since the contact body 7 is fixed to the pedestal 13 as described above, the vibrator 2 moves in the X direction.

In order to efficiently drive the vibrating actuator 1, it is preferable to support the vibrator 2 without impeding the vibrations (displacements) excited in the vibrator 2 in the two vibration modes. To this end, it is desirable to support the vibrator 2 in the vicinities of the nodes in the two vibration modes. For this reason, two projecting portions 5a are provided on the holding member 5 to press and hold the vibrator 2 at the common nodes in the two vibration modes excited in the vibrator 2. In addition, the vibrator 2 is positioned by retaining parts 5b provided on the holding member 5, which makes it possible to bring the two projecting portions 5a into contact with the vibrator 2 in the vicinities of the nodes in the two vibration modes.

The projecting portions 5a not only press the vibrator 2, but also holds the vibrator 2 by a frictional force in the X direction and Y direction. The maximum value of a static frictional force between the projecting portions 5a and the vibrator 2 is always greater than a reaction force that the vibrator 2 receives when the contact body 7 is driven, so that the vibrator 2 does not move relative to the holding member 5. This makes it possible to perform precise driving. The retaining parts 5b have notches 5e on the upper side as illustrated in FIG. 2D. If a strong force is applied due to a drop impact or the like, the notches 5e collide with the first guide member 9 to serve as a stopper that prevents the balls 10 from coming off the rolling grooves 9a and 11a.

The pressure mechanism of the present exemplary embodiment will be described. The holding member 5 that presses and holds the vibrator 2 is provided below the vibrator 2. The material of the holding member 5 is metal or resin, but a resin material is preferable from the viewpoint of workability and sliding property. Two pressure fulcrums 5c provided to the holding member 5 and two fitting parts 11b provided to the second guide member 11 are fitted to each other so as to be rotatable in a Y-axis direction. The pressure springs 6 are provided between the holding member 5 and the second guide member 11. The pressure springs 6 are tensile coil springs, but are illustrated in the drawing in a simple cylindrical shape instead of a coil shape. The projecting portions 5a are located approximately at the center in the X direction between the pressure fulcrums 5c and the pressure springs 6, and are in contact with the vibrator 2. A pressure force in the Z direction is applied to the vibrator 2 on the principle of leverage in which the pressure fulcrums 5c serve as the fulcrums, spring placement parts 5d serve as points of effort, and the projecting portions 5a serve as the points of load. The vibrator 2 is in pressure contact with the contact body 7 by the pressure force.

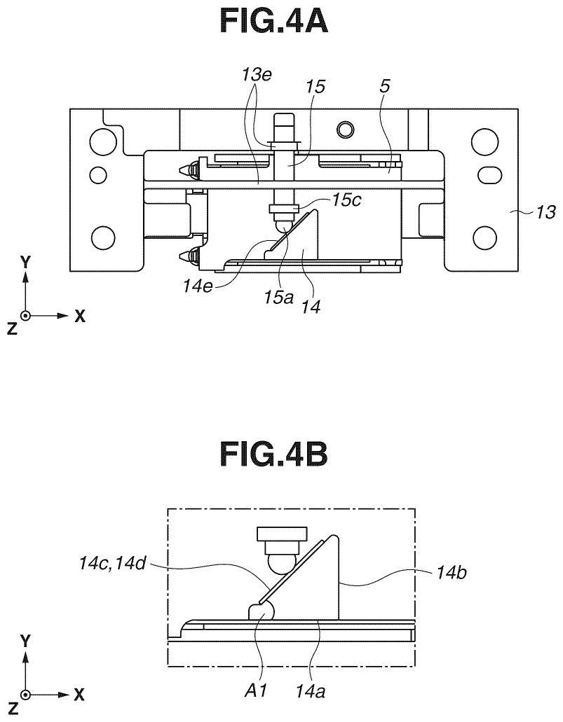

An output conversion mechanism of the present exemplary embodiment will be described with reference to FIGS. 4A and 4B. FIG. 4A is a bottom view of the vibrating actuator 1 that produces output in the Y-axis direction by a driving amount of 2 mm in the X direction, and FIG. 4B is an enlarged bottom view of a cam member 14 in the bottom view. The side on which the protrusions 3a of the elastic body 3 are formed in the Z direction is defined as an upper side, and a view seen from a lower side is defined as a bottom view. The output conversion mechanism according to the present exemplary embodiment is composed of the cam member 14, a contact plate 14e, and an output unit 15.

The cam member 14 is formed integrally with the back side of the holding member 5 where a side on which the projecting portions 5a and the retaining parts 5b of the holding member 5 are formed is the front side. The cam member 14 has a triangular shape with an apex protruding in the Z direction. The cam member 14 is arranged so as to fit within the pedestal 13.

The cam member 14 having a slope 14d is preferably arranged so as to be positioned within the holding member 5 in the Y direction and the X direction. In other words, the cam member 14 is preferably smaller in length than the holding member 5 in the Y direction and is positioned within an area occupied by the holding member 5. More preferably, in a plane that includes the Y direction and the X direction, the cam member 14 is smaller in length than the holding member 5 in the Y direction and the X direction and is positioned within a projected area of the holding member 5. With this configuration, even if the cam member 14 is provided, the vibrating actuator 1 does not become large in size and remains to be in a small shape.

The cam member 14 is formed on the holding member 5 at a position that is the center of the holding member 5 in the X direction, and in the Y direction, at a position such that a base 14a of the cam member 14 is aligned with the long side of the holding member 5 on the lower side of the drawing surface. An oblique side 14c is drawn at an angle A1 from the base 14a to form the slope 14d so as to protrude in the Z direction. The material of the cam member 14 is metal or resin, but preferably it is the same material as that of the holding member 5 from the viewpoint of ease of processing.

The output unit 15 is composed of a contact ball 15a, a shaft 15b, and a contact ball receiving part 15c. The contact ball receiving part 15c is formed on the shaft 15b, and the contact ball 15a is fixed to the shaft 15b using an adhesive material. Alternatively, the contact ball 15a may be rotatably fixed so that it can roll in a direction of movement. The contact ball 15a is preferably a sphere from the viewpoint of sliding property, and a material that is a magnet with a weak magnetic force, such as a ferrite magnet, may be used. The output unit 15 may not use the contact ball 15a and the contact ball receiving part 15c, but may be integrally molded by rounding a tip of the shaft from the viewpoint of sliding property. The shaft 15b is preferably made of a metal, such as SUS304 and SUS420J2, from the viewpoint of durability.

The contact plate 14e is fixed using an adhesive material such that the largest surface of the contact plate 14e entirely contacts the slope 14d of the cam member 14. The contact plate 14e is made of a magnetic metal, such as SUS430 and SUS410. The contact ball 15a may be made of a magnetic metal, and the contact plate 14e may be made of a magnet, so that the output unit 15 including the contact ball 15a is brought into contact with the slope 14d including the contact plate 14e by a magnetic force. Alternatively, the contact plate 14e may not be provided to a contact part, but the shaft 15b may be biased by a compression spring to bring the slope 14d of the cam member 14 into direct contact with the contact ball 15a of the output unit 15 to cause friction driving.

The cam member 14 formed integrally with the holding member 5 is driven together with the vibrator 2 in the X direction. The driving amount is not limited and can be adjusted as desired. The contact plate 14e attached to the slope 14d of the cam member 14 is attracted by a weak magnetic force at a level that does not allow the contact ball 15a of the output unit 15 to separate, and is in contact with the slope 14d. The contact ball 15a in contact with the slope 14d of the cam member 14 slides up and down on the slope 14d. The shaft 15b with the contact ball 15a attached to the contact ball receiving part 15c is fitted to two connection parts 13e provided on the pedestal 13 so as to be movable in the Y direction. The shaft 15b transmits, in the Y direction, the force of the contact ball 15a moving up and down the slope 14d. To stabilize the sliding of the output unit 15, it is preferable to provide two connection parts 13e, but the number of the connection parts is not limited to two. An output transmission mechanism (not illustrated) is fixed to the shaft 15b and produces output to the body to be driven. The output transmission mechanism is a mechanism in which a hollow part that is slidable using the shaft 15b as a guide is prepared and the part is linearly moved, for example. Therefore, the driving force in the X direction (first direction) of the holding member 5 can be converted into the driving force in the Y direction (second direction intersecting the first direction) by using the mechanism of the cam member 14 and the output unit 15. In the present exemplary embodiment, an example is described where the first direction that is the driving direction and the second direction that is the output direction are substantially perpendicular to each other. However, the first direction and the second direction may form an acute angle.

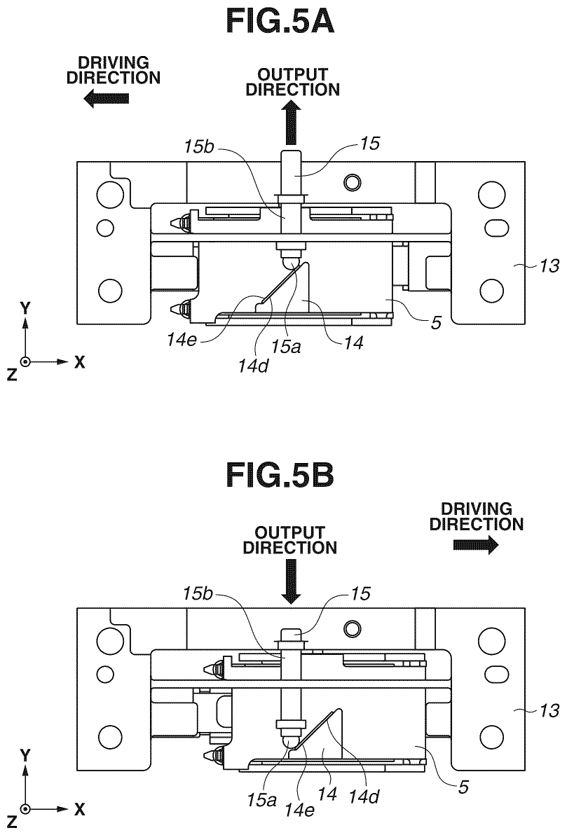

FIG. 5A is a bottom view of the vibrating actuator 1, illustrating the direction of force generation by the vibrating actuator 1 in a case where the holding member 5 moves to the left side of the drawing surface. FIG. 5B is a bottom view of the vibrating actuator 1, illustrating the direction of force generation by the vibrating actuator 1 in a case where the holding member 5 moves to the right side of the drawing surface. As illustrated in the drawings, the direction in which the vibrator 2 and the contact body 7 move relatively will be defined as the driving direction, and the direction in which the shaft 15b of the output unit 15 moves will be defined as the output direction. When the holding member 5 is driven in the direction illustrated in FIG. 5A, the shaft 15b moves in the output direction that is to the upper side of the drawing surface via the contact ball 15a of the output unit 15 that is in contact with the slope 14d of the cam member 14. Similarly, when the holding member 5 is driven in the direction illustrated in FIG. 5B, the shaft 15b moves in the output direction that is to the lower side of the drawing surface via the contact ball 15a of the output unit 15 that is in contact with the slope 14d of the cam member 14.

Using the output conversion mechanism makes it possible to convert only the output direction to the Y-axis direction without changing the driving direction. The angle A1 of the slope 14d of the cam member 14 that intersects with the X direction is set to 45° to form an isosceles right triangle. Accordingly, the two sides of the cam member 14 other than the oblique side 14c, namely, the base 14a and a height 14b become the same in length. As a result, the driving amount and the output amount are equal, so that when being driven 1 mm to each of left and right directions, the vibrating actuator 1 generates an output of 1 mm in each of up and down directions. By arranging the output conversion mechanism inside the vibrating actuator 1, miniaturization of the vibrating actuator 1 can be achieved without upsizing due to the output conversion mechanism.

The output direction is not limited to the Y direction, but may be the Z direction.

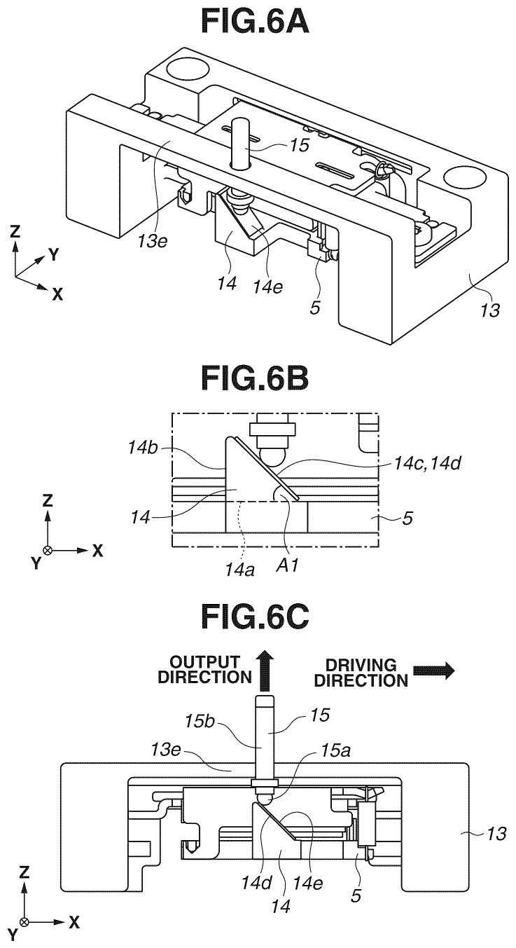

FIG. 6A is an isometric projection view of a vibrating actuator 1 according to a first modified example of the vibrating actuator 1 according to the present exemplary embodiment. In the isometric projection view, the driving amount is 2 mm in the X direction, and the output direction is the Z direction. A cam member 14 is arranged on the side of a holding member 5.

FIG. 6B is an enlarged front view of the cam member 14, and FIG. 6C is a front view of the vibrating actuator 1, illustrating the direction of force generation by the vibrating actuator 1 in a case where a holding member 5 moves to the right side of the drawing surface.

The cam member 14 is formed in a triangular shape such that, when a surface on which projecting portions 5a and retaining parts 5b of the holding member 5 are formed is defined as a front surface, the holding member 5 extends in the Y direction, and the cam member 14 integrally forms a projecting shape in the Z direction on the front surface. The cam member 14 is arranged so as to fit within the pedestal 13. The cam member 14 is formed on the holding member 5 at a position that is the center of the holding member 5 in the X direction, and in the Y direction, at a position such that the front surface of the holding member 5 and a base 14a of the cam member 14 are aligned with the extension of the holding member 5 in the Y direction. An oblique side 14c is drawn at an angle A1 from the base 14a to form the slope 14d so as to protrude in the Z direction.

On the same principle as that for the configuration for outputting in the Y direction described above, the driving force of the holding member 5 in the X direction can be converted into that in the Z direction by using the mechanism of the cam member 14 and the output unit 15.

As described above, conventionally, the output direction has been limited to the same direction as the driving direction. However, in the exemplary embodiment, the output conversion mechanism that converts the output direction into the Y direction or Z direction without changing the driving direction is used to improve the design flexibility.

Furthermore, depending on the configuration of the vibrating actuator 1, setting, as the output direction, either the Y direction or the Z direction in which the vibrating actuator 1 is smaller in dimension allows the dimension of the vibrating actuator 1 in the output direction to be the smallest.

In the linear vibrating actuator of the present disclosure, the method for generating an elliptic or circular motion on a contact surface is not limited to the above-mentioned method. For example, vibrations in bending vibration modes different from the above-described ones may be combined, or vibrations in a longitudinal vibration mode that expands and contracts an elastic body in the longitudinal direction may be combined with vibrations in a bending vibration mode.

Any driving method may be used as long as the method generates an elliptic or circular motion on the contact surface by combining a vibration mode in which the contact surface is displaced in a movement direction of the contact body and a vibration mode in which the contact surface is displaced in a pressure direction and the method has a common node for pressurization and holding.

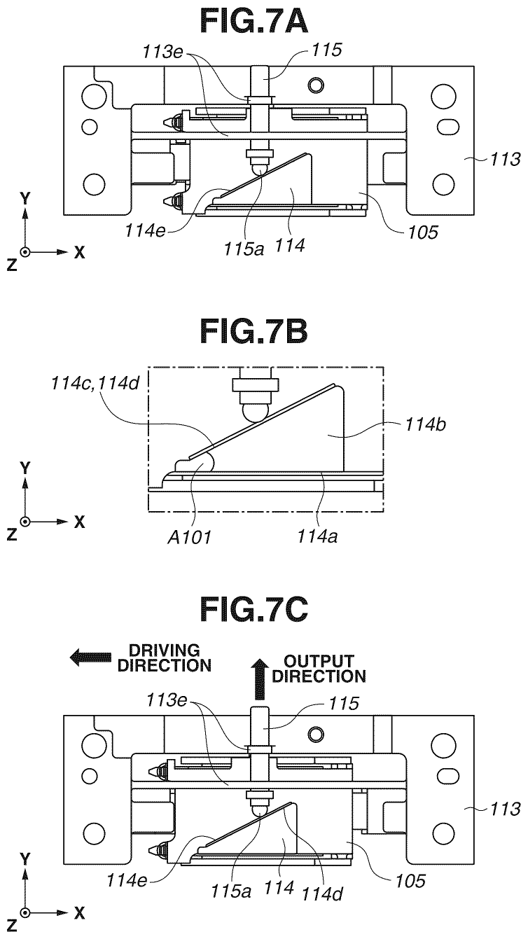

As a second exemplary embodiment, a configuration example of a vibrating actuator different in form from that according to the first exemplary embodiment will be described with reference to FIGS. 7A to 7C. The present exemplary embodiment has a structure different from the structure illustrated in FIG. 1 in the first exemplary embodiment in that a cam member 14 provided on the holding member 5 is configured as illustrated in FIGS. 7A to 7C. Other components of the present exemplary embodiment are identical to the corresponding components of the first exemplary embodiment described above, so descriptions thereof will be omitted, and the last two digits of the reference numerals are made the same. The present exemplary embodiment is configured to obtain more output than the driving force. FIG. 7A is a bottom view of the vibrating actuator that produces output in the Y-axis direction by a driving amount of 2 mm in the X direction, FIG. 7B is an enlarged bottom view of a cam member 114, and FIG. 7C is a bottom view of the vibrating actuator that is driven to the left side of the drawing surface, illustrating the generation of force by the vibrating actuator.

The present exemplary embodiment will be described with reference to a case where an angle A101 of a slope 114d provided on the cam member 114 is set to about 27°. Any angle of the slope more than 0° and less than 450 is applicable to the present exemplary embodiment.

The angle A101 of the slope 114d provided on the cam member 114 is set to about 27° to form a right triangle. Accordingly, a base 114a: a height 114b=2:1, and when a holding member 105 moves 1 mm in the driving direction illustrated in FIG. 7C, an output unit 115 in contact with the slope 114d of the cam member 114 moves 0.5 mm in the output direction that is to the upper side of the drawing surface. When the holding member 105 is driven to the right side of the drawing surface, the cam member 114 moves in the direction opposite to the left side of the drawing surface in the same manner as the first exemplary embodiment described with reference to FIGS. 5A and 5B, and thus the description thereof will be omitted. In other words, a deceleration mechanism is implemented in which the amount of movement is halved and the thrust force is doubled.

Accordingly, in the present exemplary embodiment, a configuration that provides a thrust force larger than the driving force is achieved. Therefore, when the thrust force larger than that in the first exemplary embodiment is desired, it is possible to increase the thrust force without changing the size of the vibrating actuator 1.

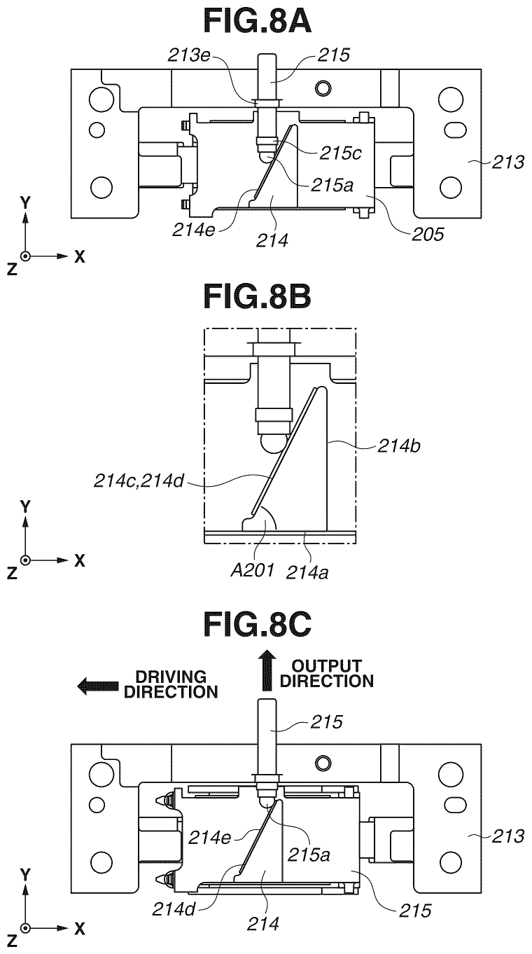

As a third exemplary embodiment, a configuration example of a vibrating actuator different in form from that according to the first exemplary embodiment will be described with reference to FIGS. 8A to 8C. The present exemplary embodiment has a structure different from the structure illustrated in FIG. 1 in the first exemplary embodiment in that a cam member 14 provided on the holding member 5 is configured as illustrated in FIGS. 8A to 8C. Other components of the present exemplary embodiment are identical to the corresponding components of the first exemplary embodiment described above, so descriptions thereof will be omitted, and the last two digits of the reference numerals are made the same. The present exemplary embodiment is configured to obtain the amount of movement in the output direction that is larger than the amount of movement in the driving direction. FIG. 8A is a bottom view of a vibrating actuator that produces output in the Y-axis direction by a driving amount of 2 mm in the X direction, FIG. 8B is an enlarged bottom view of a cam member 214, and FIG. 8C is a bottom view of the vibrating actuator that is driven to the left side of the drawing surface, illustrating the generation of force by the vibrating actuator.

The present exemplary embodiment will be described with reference to a case where an angle A201 of a slope 214d provided on the cam member 214 is set to about 64°. Any angle of the slope 214d larger than 450 and smaller than 90° is applicable to the present exemplary embodiment.

The angle A201 of the slope 214d provided on the cam member 214 is set to about 64°, and a right triangle is formed. Accordingly, a base 214a: a height 214b=1:2, and when a holding member 205 moves 1 mm in the driving direction illustrated in FIG. 8C, an output unit 215 in contact with the slope 214d of the cam member 214 moves 2 mm in the output direction that is to the upper side of the drawing surface. When the holding member 205 is driven to the right side of the drawing surface, the cam member 214 moves in the direction opposite to the left side of the drawing surface in the same manner as the first exemplary embodiment described with reference to FIGS. 5A and 5B, and thus the description thereof will be omitted.

Accordingly, in the present exemplary embodiment, the amount of movement in the output direction can be made larger than the amount of movement in the driving direction. Therefore, when it is desired to make the amount of movement in the output direction larger than that in the first exemplary embodiment, it is possible to increase the amount of movement in the output direction without changing the size of the vibrating actuator 1. In addition, when the same amount of movement in the output direction as that in the first exemplary embodiment is desired, the amount of movement in the driving direction becomes half the amount of movement in the output direction, thereby further size reduction of the vibrating actuator 1 in the X direction becomes possible.

A vibrating actuator can be used to drive a lens in an imaging apparatus that is an example of an optical device, for example. In a fourth exemplary embodiment, an imaging apparatus using a vibrating actuator to drive a lens arranged in a lens barrel will be described as an example.

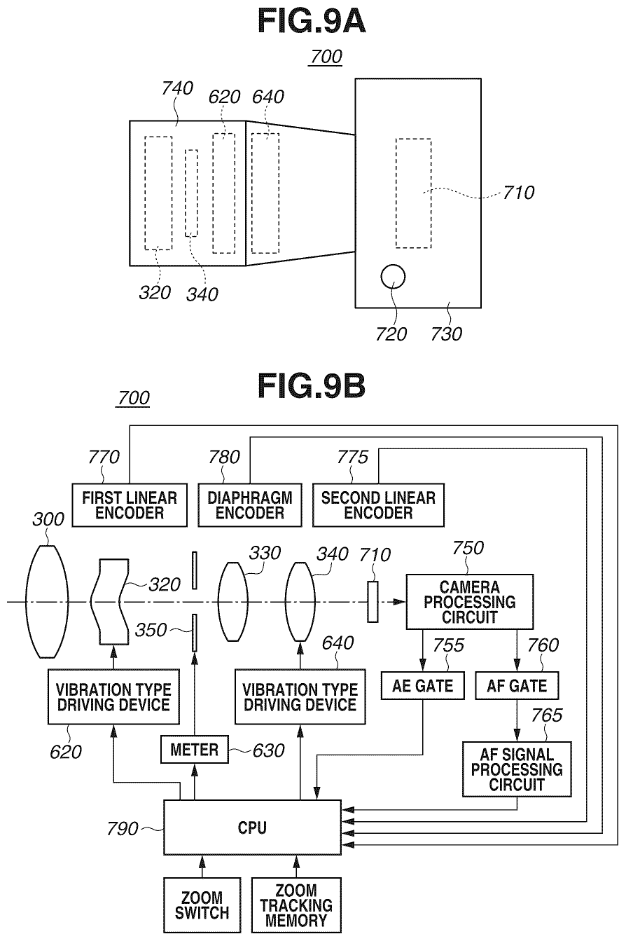

FIG. 9A is a top view schematically illustrating a configuration of an imaging apparatus 700. The imaging apparatus 700 includes a camera body 730 that is equipped with an imaging element 710 and a power button 720. The imaging apparatus 700 also includes a lens barrel 740 that includes a first lens group (not illustrated), a second lens group 320, a third lens group (not illustrated), a fourth lens group 340, which are examples of an optical element, and vibrating actuators 620 and 640. The lens barrel 740 is replaceable as an interchangeable lens. The lens barrel 740 suitable for a subject to be imaged can be attached to the camera body 730. In the imaging apparatus 700, the second lens group 320 and the fourth lens group 340 are driven by the two vibrating actuators 620 and 640, respectively.

Although the detailed configuration of the vibrating actuator 620 is not illustrated, the vibrating actuator 620 includes a vibrating actuator and a drive circuit for the vibrating actuator. A rotor is arranged in the lens barrel 740 such that a radial direction thereof is substantially orthogonal to the optical axis. In the vibrating actuator 620, the rotor is rotated around the optical axis, and rotation output of the contact body is converted into linear motion in an optical-axis direction via a gear or the like (not illustrated), thereby moving the second lens group 320 in the optical-axis direction. The vibrating actuator 640 has a configuration similar to that of the vibrating actuator 620, and moves the fourth lens group 340 in the optical-axis direction.

FIG. 9B is a block diagram schematically illustrating a configuration of the imaging apparatus 700. The lens barrel 740 includes a first lens group 300, the second lens group 320, a third lens group 330, a fourth lens group 340, and a light amount adjustment unit 350 arranged at predetermined positions on the optical axis inside the lens barrel 740. Light having passed through the first lens group 300 to the fourth lens group 340 and the light amount adjustment unit 350 forms an image on the imaging element 710. The imaging element 710 converts the optical image into an electrical signal and outputs the electrical signal, and the output is transmitted to a camera processing circuit 750.

The camera processing circuit 750 performs amplification, gamma correction, and the like on an output signal from the imaging element 710. The camera processing circuit 750 is connected to a central processing unit (CPU) 790 via an auto exposure (AE) gate 755, and is also connected to the CPU 790 via an auto focus (AF) gate 760 and an AF signal processing circuit 765. The video signal that has undergone predetermined processing in the camera processing circuit 750 is transmitted to the CPU 790 via the AE gate 755, the AF gate 760, and the AF signal processing circuit 765. The AF signal processing circuit 765 extracts high-frequency components from the video signal to generate an evaluation value signal for AF, and supplies the generated evaluation value signal to the CPU 790.

The CPU 790 is a control circuit that controls the overall operation of the imaging apparatus 700, and generates control signals for exposure determination and focusing from the acquired video signal. The CPU 790 controls driving of the vibrating actuators 620 and 640 and a meter 630 to adjust positions of the second lens group 320, the fourth lens group 340, and the light amount adjustment unit 350 in the optical-axis direction, so that the determined exposure and an appropriate focus state can be obtained. Under the control of the CPU 790, the vibrating actuator 620 moves the second lens group 320 in the optical-axis direction, the vibrating actuator 640 moves the fourth lens group 340 in the optical-axis direction, and the light amount adjustment unit 350 is driven and controlled by the meter 630.

The position in the optical-axis direction of the second lens group 320 driven by the vibrating actuator 620 is detected by a first linear encoder 770, and a detection result is notified to the CPU 790, so that feedback is provided to the driving by the vibrating actuator 620. Similarly, the position in the optical-axis direction of the fourth lens group 340 driven by the vibrating actuator 640 is detected by a second linear encoder 775, and a detection result is notified to the CPU 790, so that feedback is provided to the driving by the vibrating actuator 640. The position in the optical-axis direction of the light amount adjustment unit 350 is detected by a diaphragm encoder 780, and a detection result is notified to the CPU 790, so that feedback is provided to the driving by the meter 630.

Another configuration of the present disclosure may be an electronic device that includes the vibrating actuator described in relation to the first to third exemplary embodiments, and members to be driven by the vibrating actuator. The electronic device may be a factory automation (FA) device or an office automation (OA) device, for example.

Disclosure of the present exemplary embodiment includes the following configurations:
1. A vibrating actuator including a vibrator including an electromechanical energy conversion element and an elastic body, and a contact body in contact with the vibrator, the vibrator and the contact body moving relatively in a first direction, the vibrating actuator comprising:
a pedestal;
a holding member configured to hold the vibrator, held on the pedestal, having a slope intersecting with the first direction, and moving in the first direction along with relative movement of the vibrator; and
an output unit held on the pedestal so as to be movable in a second direction intersecting with the first direction, being in contact with the slope, and moving along with the movement of the holding member.
2. The vibrating actuator according to configuration 1, wherein the slope is smaller in length than the holding member in the second direction and is positioned within an area occupied by the holding member.
3. The vibrating actuator according to configuration 1 or 2, wherein, in a plane including the first direction and the second direction, the slope is smaller in length than the holding member in the first direction and in the second direction, and is positioned within a projected area of the holding member.
4. The vibrating actuator according to any one of configurations 1 to 3, wherein the output unit is in contact with the slope by at least one of a magnet and a spring.
5. The vibrating actuator according to any one of configurations 1 to 4, wherein the slope forms an angle of 45° with the first direction.
6. The vibrating actuator according to any one of configurations 1 to 4, wherein an angle formed by the slope and the first direction is larger than 0° and smaller than 45°.
7. The vibrating actuator according to any one of configurations 1 to 4, wherein an angle formed by the slope and the first direction is larger than 45° and smaller than 90°.
8. The vibrating actuator according to any one of configurations 1 to 7, wherein the first direction and the second direction are substantially orthogonal to each other.
9. The vibrating actuator according to any one of configurations 1 to 8, wherein the vibrator is rectangular, and a long-side direction of the vibrator is the same as the first direction.
10. The vibrating actuator according to any one of configurations 1 to 9, wherein the elastic body has two protrusions, and the protrusions and the contact body are in contact with each other.
11. An optical device comprising:
the vibrating actuator according to any one of configurations 1 to 10; and
an optical element and an imaging element, at least one of the optical element and the imaging element being driven by the vibrating actuator.
12. An electronic device comprising:
a member; and
the vibrating actuator according to any one of configurations 1 to 10 configured to drive the member.

According to the present disclosure, it is possible to provide a vibrating actuator with an improved design flexibility. In addition, according to the present disclosure, it is possible to provide an optical device and an electronic device including a vibrating actuator with an improved degree of design freedom.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2023-169956, filed Sep. 29, 2023, which is hereby incorporated by reference herein in its entirety.

1. A vibrating actuator including a vibrator including an electromechanical energy conversion element and an elastic body, and a contact body in contact with the vibrator, the vibrator and the contact body moving relatively in a first direction, the vibrating actuator comprising:
a pedestal;
a holding member configured to hold the vibrator, held on the pedestal, having a slope intersecting with the first direction, and moving in the first direction along with relative movement of the vibrator; and
an output unit held on the pedestal so as to be movable in a second direction intersecting with the first direction, being in contact with the slope, and moving along with the movement of the holding member.

2. The vibrating actuator according to claim 1, wherein the slope is smaller in length than the holding member in the second direction and is positioned within an area occupied by the holding member.

3. The vibrating actuator according to claim 2, wherein, in a plane including the first direction and the second direction, the slope is smaller in length than the holding member in the first direction and in the second direction, and is positioned within a projected area of the holding member.

4. The vibrating actuator according to claim 1, wherein the output unit is in contact with the slope by at least one of a magnet and a spring.

5. The vibrating actuator according to claim 1, wherein the slope forms an angle of 45° with the first direction.

6. The vibrating actuator according to claim 1, wherein an angle formed by the slope and the first direction is larger than 0° and smaller than 45°.

7. The vibrating actuator according to claim 1, wherein an angle formed by the slope and the first direction is larger than 45° and smaller than 90°.

8. The vibrating actuator according to claim 1, wherein the first direction and the second direction are substantially orthogonal to each other.

9. The vibrating actuator according to claim 1, wherein the vibrator is rectangular, and a long-side direction of the vibrator is the same as the first direction.

10. The vibrating actuator according to claim 1, wherein the elastic body has two protrusions, and the protrusions and the contact body are in contact with each other.

11. An optical device comprising:
the vibrating actuator according to claim 1; and
an optical element and an imaging element, at least one of the optical element and the imaging element being driven by the vibrating actuator.

12. An electronic device comprising:
a member; and
the vibrating actuator according to claim 1 configured to drive the member.
